(19) United States
(12) Patent Application Publication
(10) Pub. No.: US 2026/0300052 A1
(43) Pub. Date: Oct. 1, 2026

(54) Survivability-Oriented Intelligent Runtime Participation Platform

(71) Applicant: Xinxin Shan, Surrey (CA)

(72) Inventor: Xinxin Shan, Surrey (CA)

(73) Assignee: LED Smart Inc, Surrey (CA)

(21) Appl. No.: 19/679,494

(22) Filed: May 15, 2026

(51) Int. Cl. G06F 9/54

(52) U.S. Cl. CPC G06F 9/544

(57) ABSTRACT

A survivability-oriented intelligent runtime participation platform comprising Runtime Memory Participation structures, Operational Participation Density governance, selective runtime participation contraction, reconstructable continuity preservation, behavioral-relational continuity preservation, and survivability-oriented runtime stabilization under bounded engineering resource conditions. Operational Participation Density governs simultaneous runtime participation pressure associated with replay participation, synchronization participation, federation participation, governance participation, observability participation, Runtime Memory Participation, artificial intelligence participation, or combinations thereof. Increasing runtime participation pressure contracts active runtime participation toward bounded survivability-useful runtime participation domains while preserving reconstructable continuity and admissibility-governed runtime continuity. The platform further enables distributed runtime survivability stabilization, intrinsic Runtime Memory Participation activation, dynamic operational memory participation redistribution, replay containment governance, bounded runtime participation continuity, and survivability-preserving runtime reconstruction under dynamically changing operational runtime conditions without depending upon unrestricted computational expansion, unrestricted replay amplification, or unrestricted synchronization expansion.

### CROSS-REFERENCE TO RELATED APPLICATIONS

No claim of priority is made to any prior-filed application. The present application may be related in subject matter to other governance-oriented runtime survivability, Runtime Memory Participation, admissibility-governed runtime architecture, lineage continuity, bounded operational participation, and reconstructable continuity systems to the extent consistent with the present disclosure.

### PRIOR ART

The references listed below are provided for verification and examination support purposes and correspond to publicly accessible patent documents.

The inclusion of any reference herein is not an admission that such reference is material to patentability, is relevant to the claimed subject matter, or constitutes prior art against the present disclosure.

U.S. PATENT DOCUMENTS

| | |
|---|---|
| U.S. Pat. No. 9,767,284 B2 | 09/2017 Ghose |
| U.S. Pat. No. 6,854,108 B1 | 02/2005 Choi |
| U.S. Pat. No. 8,578,340 B1 | 11/2013 Daudel et al. |
| U.S. Pat. No. 8,442,941 B2 | 05/2013 Yao et al. |
| U.S. Pat. No. 11,556,431 B2 | 01/2023 Simon et al. |
| U.S. Pat. No. 9,348,879 B2 | 05/2016 Mohammad et al. |
| U.S. Pat. No. 9,075,860 B2 | 07/2015 Kozina et al. |
| U.S. Pat. No. 8,832,665 B2 | 09/2014 Greifeneder et al. |
| U.S. Pat. No. 9,037,812 B2 | 05/2015 Chew |
| U.S. Pat. No. 7,401,234 B2 | 07/2008 Case et al. |
| U.S. Pat. No. 10,379,842 B2 | 08/2019 Malladi et al. |
| U.S. Pat. No. 10,007,513 B2 | 06/2018 Malladi et al. |
| U.S. Pat. No. 11,330,087 B2 | 05/2022 Wouhaybi et al. |
| US 2021/0117242 A1 | 04/2021 Groenendaal et al. |
| U.S. Pat. No. 8,249,042 B2 | 08/2012 Sparr et al. |
| US 2005/0201340 A1 | 09/2005 Wang et al. |
| U.S. Pat. No. 7,336,642 B2 | 02/2008 Rich et al. |
| U.S. Pat. No. 10,383,069 B2 | 08/2019 Nguyen-Dang |
| U.S. Pat. No. 11,265,799 B2 | 03/2022 Tao et al. |
| U.S. Pat. No. 10,728,751 B2 | 07/2020 Lahteenmaki et al. |
| U.S. Pat. No. 8,532,023 B2 | 09/2013 Buddhikot et al. |
| U.S. Pat. No. 8,233,905 B2 | 07/2012 Vaswani et al. |
| U.S. Pat. No. 11,646,940 B2 | 05/2023 Prasad et al. |
| U.S. Pat. No. 11,348,597 B2 | 05/2022 Hill et al. |
| U.S. Pat. No. 10,705,808 B2 | 07/2020 Chiosi et al. |

### BACKGROUND OF THE INVENTION

Conventional distributed runtime systems, artificial intelligence systems, replay systems, synchronization systems, and federated runtime coordination systems generally rely upon continuously expanding operational participation, unrestricted replay expansion, unrestricted synchronization participation, unrestricted distributed coordination participation, or unrestricted computational scaling in order to preserve runtime continuity under increasing operational pressure conditions. Such architectures frequently produce runtime instability, synchronization collapse, replay amplification, participation congestion, uncontrollable runtime expansion, survivability degradation, lineage inconsistency, or unrecoverable runtime fragmentation under constrained engineering resource conditions, degraded environments, distributed participation conditions, contested runtime conditions, or combinations thereof.

Existing runtime architectures also frequently fail to preserve bounded survivability-oriented runtime participation continuity under dynamically changing runtime participation density conditions associated with replay participation, synchronization participation, governance participation, observability participation, federation participation, Runtime Memory Participation, artificial intelligence participation, or combinations thereof. Conventional runtime architectures may not sufficiently provide survivability-oriented mechanisms configured to selectively contract runtime participation toward bounded survivability-useful runtime participation domains while preserving reconstructable continuity and behavioral-relational continuity.

### SUMMARY OF THE INVENTION

The present disclosure defines a survivability-oriented runtime constitutional operating architecture configured to preserve bounded long-duration operational runtime survivability through dynamically governed operational runtime participation under bounded engineering resource conditions.

The disclosed architecture introduces Runtime Memory Participation structures configured to preserve survivability-oriented runtime continuity through admissibility-governed runtime participation stabilization, reconstructable continuity preservation, behavioral-relational continuity preservation, and Operational Participation Density governance. Operational Participation Density represents simultaneous operational runtime participation pressure associated with runtime memory participation, replay participation, synchronization participation, governance participation, federation participation, observability participation, artificial intelligence participation, or combinations thereof.

The disclosed architecture further enables selective runtime participation contraction, bounded runtime survivability stabilization, reconstructable runtime continuity preservation, dynamic operational memory participation redistribution, distributed runtime survivability participation, intrinsic Runtime Memory Participation activation, replay containment governance, and survivability-preserving runtime participation continuity under dynamically changing runtime participation pressure conditions without depending upon unrestricted computational expansion, unrestricted replay amplification, or unrestricted synchronization expansion.

### BRIEF DESCRIPTION OF DRAWINGS

FIG. 1—Intelligent Runtime Participation Constitutional Domain

FIG. 2—Selective Runtime Participation and Bounded Participation Structure

FIG. 3—Runtime Memory Participation and Intrinsic Participation Structure

FIG. 4—Behavioral-Relational Reconstructable Continuity Structure

FIG. 5—Participation Ecology and Survivability Stabilization Structure

### DETAILED DESCRIPTION OF THE INVENTION

The following description defines structural relationships of an intelligent survivability-oriented runtime participation platform in which Runtime Memory Participation, Operational Participation Density governance, bounded runtime participation, behavioral-relational continuity, reconstructable continuity, participation contraction, intrinsic Runtime Memory

Participation, and survivability participation stabilization exist as admissibility-governed constitutional runtime participation domains within a unified runtime survivability architecture. All elements correspond to structural existence, survivability-oriented runtime participation conditions, participation pressure conditions, bounded participation conditions, reconstructable continuity conditions, admissibility conditions, participation contraction conditions, and survivability stabilization relationships, and do not correspond to procedural sequencing, algorithmic execution ordering, transformation procedures, routing procedures, workflow determination, orchestration procedures, or unrestricted computational expansion behavior. All elements constitute a non-separable unified runtime survivability constitutional architecture.

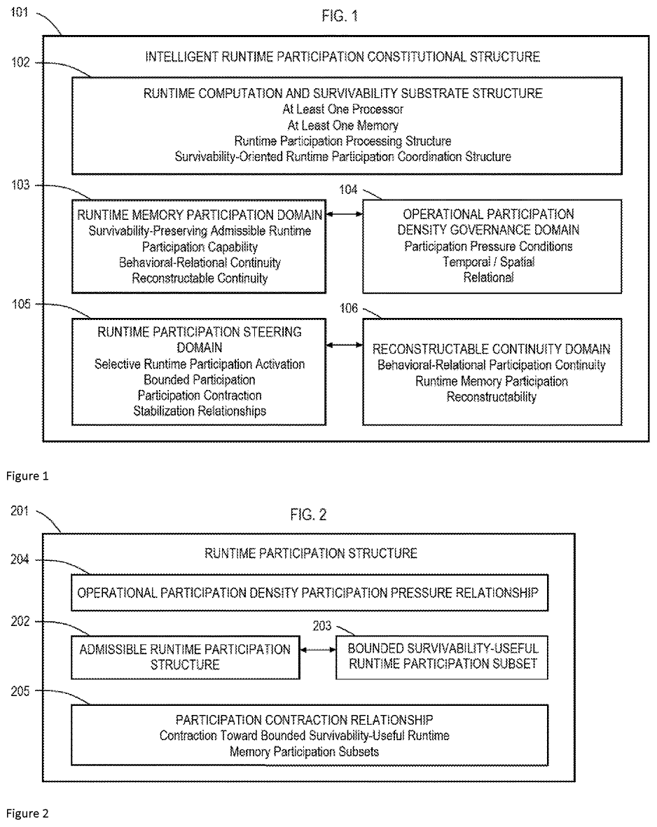

### FIG. 1—Intelligent Runtime Participation Constitutional Domain

An intelligent runtime participation constitutional structure 101 is defined as a unified survivability-oriented runtime participation domain.

A runtime computation and survivability substrate structure 102 comprising at least one processor, at least one memory, at least one runtime participation processing structure, and at least one survivability-oriented runtime participation coordination structure is defined within intelligent runtime participation constitutional structure 101.

A Runtime Memory Participation Domain 103, an Operational Participation Density governance domain 104, a runtime participation steering domain 105, and a reconstructable continuity domain 106 are defined within intelligent runtime participation constitutional structure 101 and structurally associated with runtime computation and survivability substrate structure 102.

Runtime computation and survivability substrate structure 102 corresponds to constitutional runtime participation support associated with Runtime Memory Participation, Operational Participation Density governance, bounded runtime participation, reconstructable continuity, participation contraction relationships, intrinsic Runtime Memory Participation activation relationships, distributed runtime participation continuity relationships, survivability participation stabilization relationships, and admissibility-governed runtime participation coordination relationships.

Runtime Memory Participation Domain 103 corresponds to survivability-preserving admissible runtime participation capability associated with behavioral-relational continuity, reconstructable continuity, intrinsic Runtime Memory Participation activation, and bounded survivability-oriented runtime participation preservation.

Operational Participation Density governance domain 104 corresponds to survivability-oriented runtime participation pressure associated with temporal participation conditions, spatial participation conditions, relational participation conditions, continuity conditions, participation survivability cost conditions, or combinations thereof.

Runtime participation steering domain 105 corresponds to selective runtime participation activation, bounded participation control, participation contraction relationships, survivability participation stabilization relationships, layered runtime participation relationships, or combinations thereof.

Reconstructable continuity domain 106 corresponds to reconstructable behavioral-relational participation continuity associated with Runtime Memory Participation structures, distributed runtime participation continuity relationships, and survivability-preserving runtime participation reconstructability relationships.

Domains 103-106 exist as structurally related survivability-oriented runtime participation domains associated with runtime participation admissibility, bounded participation relationships, participation pressure relationships, reconstructable continuity relationships, participation contraction relationships, intrinsic Runtime Memory Participation relationships, and survivability stabilization relationships.

### FIG. 2—Selective Runtime Participation and Bounded Participation Structure

A runtime participation structure 201 is defined within runtime participation steering domain 105.

An admissible runtime participation structure 202 and a bounded survivability-useful runtime participation subset 203 are defined within runtime participation structure 201.

An Operational Participation Density participation pressure relationship 204 is structurally associated with runtime participation structure 201.

A participation contraction relationship 205 is structurally associated with increasing Operational Participation Density conditions.

Participation contraction relationship 205 corresponds to contraction of active runtime participation toward bounded survivability-useful Runtime Memory Participation subsets under increasing Operational Participation Density conditions.

Bounded survivability-useful runtime participation subset 203 corresponds to suppression of unrestricted active runtime participation expansion under increasing Operational Participation Density conditions.

Runtime participation structures lacking bounded survivability-useful runtime participation subset relationships correspond to non-stabilized runtime survivability participation structures.

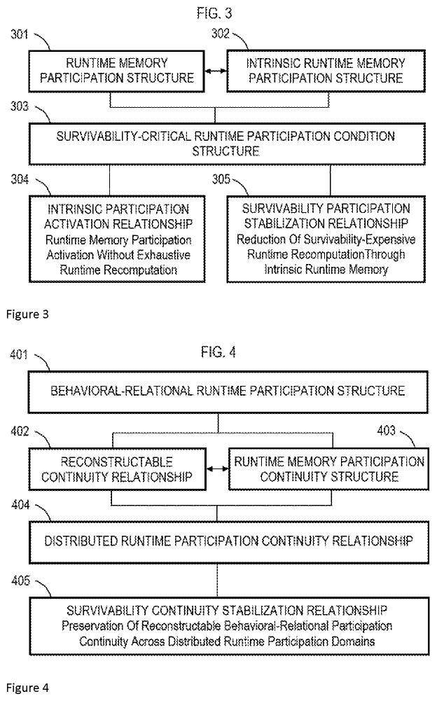

### FIG. 3—Runtime Memory Participation and Intrinsic Participation Structure

A Runtime Memory Participation structure 301 is defined within Runtime Memory Participation Domain 103.

An intrinsic Runtime Memory Participation structure 302 is structurally associated with Runtime Memory Participation structure 301.

A survivability-critical runtime participation condition structure 303 is structurally associated with intrinsic Runtime Memory Participation structure 302.

An intrinsic participation activation relationship 304 corresponds to Runtime Memory Participation activation under survivability-critical runtime participation conditions without exhaustive runtime recomputation and without unrestricted runtime participation expansion.

A survivability participation stabilization relationship 305 corresponds to reduction of survivability-expensive runtime recomputation through intrinsic Runtime Memory Participation.

Runtime participation structures associated with intrinsic participation activation relationship 304 correspond to survivability-preserving runtime participation stabilization structures.

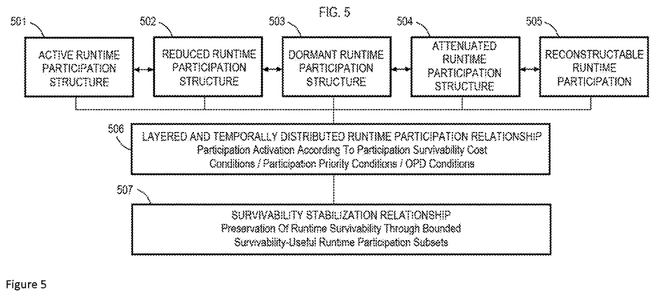

### FIG. 4—Behavioral-Relational Reconstructable Continuity Structure

A behavioral-relational runtime participation structure 401 is defined within reconstructable continuity domain 106.

A reconstructable continuity relationship 402 is structurally associated with behavioral-relational runtime participation structure 401.

A Runtime Memory Participation continuity structure 403 is structurally associated with reconstructable continuity relationship 402.

A distributed runtime participation continuity relationship 404 is structurally associated with Runtime Memory Participation continuity structure 403.

A survivability continuity stabilization relationship 405 corresponds to preservation of reconstructable behavioral-relational participation continuity across distributed runtime participation domains.

Runtime participation structures lacking reconstructable continuity relationship 402 correspond to non-stabilized runtime survivability participation structures.

### FIG. 5—Participation Ecology and Survivability Stabilization Structure

An active runtime participation structure 501, a reduced runtime participation structure 502, a dormant runtime participation structure 503, an attenuated runtime participation structure 504, and a reconstructable runtime participation structure 505 are defined within runtime participation steering domain 105.

Structures 501-505 correspond to structurally related runtime participation ecology states associated with survivability-oriented runtime participation stabilization.

A layered and temporally distributed runtime participation relationship 506 is structurally associated with runtime participation structures 501-505.

Layered and temporally distributed runtime participation relationship 506 corresponds to participation activation according to participation survivability cost conditions, participation priority conditions, Operational Participation Density conditions, or combinations thereof.

A survivability stabilization relationship 507 corresponds to preservation of runtime survivability through bounded survivability-useful runtime participation subsets associated with Runtime Memory Participation structures.

Runtime participation ecology structures associated with survivability stabilization relationship 507 correspond to stabilized intelligent survivability-oriented runtime participation structures.

The following description defines constitutional engineering relationships associated with survivability-oriented runtime participation, Runtime Memory Participation, Operational Participation Density, participation contraction, reconstructable continuity, runtime participation ecology stabilization, distributed runtime survivability, autonomous runtime survivability, governance stabilization, intrinsic Runtime Memory Participation activation, bounded runtime participation, cross-domain runtime survivability, survivability-oriented runtime participation continuity, lineage continuity, and constitutional runtime participation domains associated with survivability-preserving admissible runtime participation boundaries.

All disclosed runtime participation relationships correspond to survivability-oriented constitutional runtime participation conditions, reconstructable continuity conditions, runtime participation ecology conditions, runtime stabilization conditions, distributed runtime survivability conditions, governance conditions, bounded survivability participation conditions, runtime admissibility conditions, lineage continuity conditions, and constitutional runtime participation boundary conditions, and do not correspond to unrestricted computational expansion requirements, unrestricted replay expansion requirements, unrestricted synchronization expansion requirements, unrestricted distributed coordination expansion requirements, unrestricted runtime propagation requirements, unrestricted runtime execution requirements, unrestricted historical runtime preservation requirements, unrestricted persistent runtime activation requirements, unrestricted runtime accumulation requirements, unrestricted runtime participation growth requirements, or centralized orchestration scheduling requirements.

All disclosed relationships are non-limiting engineering examples and do not limit constitutional scope, deployment scope, runtime topology scope, autonomous runtime scope, distributed runtime scope, infrastructure scope, communication scope, governance scope, memory architecture scope, survivability scope, runtime participation scope, heterogeneous runtime participation scope, lineage scope, or constitutional runtime participation domain scope.

All disclosed runtime participation domains constitute a unified non-separable survivability-oriented runtime participation constitutional architecture.

### Foundational Runtime Survivability Principle

The disclosed intelligent runtime participation platform differs fundamentally from unrestricted runtime computational expansion architectures.

Conventional runtime architectures often increase runtime participation according to increasing runtime participation pressure conditions. Such architectures may respond to increasing runtime participation pressure by increasing runtime computation, runtime synchronization, runtime replay, runtime coordination, runtime participation execution structures, runtime propagation, runtime memory activation, distributed runtime communication, runtime reconstruction participation, or combinations thereof.

Accordingly, increasing runtime participation pressure in conventional architectures often causes increasing unrestricted active runtime participation expansion.

The disclosed intelligent survivability-oriented runtime participation platform instead preserves runtime survivability through Operational Participation Density-guided selective Runtime Memory Participation, bounded survivability-useful runtime participation subsets, participation contraction, behavioral-relational reconstructable continuity, lineage continuity, intrinsic Runtime Memory Participation, runtime participation ecology stabilization, governance stabilization, distributed reconstructable continuity, and survivability-oriented runtime participation stabilization.

Thus, increasing runtime participation pressure does not necessarily increase unrestricted runtime participation expansion.

Instead, increasing runtime participation pressure may increase participation contraction associated with survivability stabilization and may contract active runtime participation toward bounded survivability-useful Runtime Memory Participation subsets associated with survivability stabilization.

Runtime survivability stabilization does not constitutionally depend upon unrestricted runtime participation activation density.

Selective Runtime Memory Participation continuity preservation may increase runtime survivability stabilization under elevated runtime participation pressure conditions.

Partial runtime participation continuity may remain survivability-preserving despite suppression of survivability-noncritical runtime participation structures.

The disclosed architecture does not require unrestricted persistent preservation of all historical runtime participation structures.

### Runtime Participation Inversion Law

The disclosed architecture may correspond to a runtime participation inversion relationship.

Conventional unrestricted runtime computational expansion architectures may generally correspond to:
runtime participation pressure increase→synchronization increase→replay increase →runtime computation increase→active runtime participation increase.

The disclosed architecture instead corresponds to:
runtime participation pressure increase→Operational Participation Density increase participation contraction increase→selective Runtime Memory Participation stabilization increase→bounded survivability participation increase→runtime survivability stabilization increase.

Accordingly:
active runtime participation/unrestricted historical runtime accumulation.

Instead:
active runtime participation=bounded survivability-useful Runtime Memory Participation subsets associated with survivability stabilization.

This inversion relationship constitutes one of the principal engineering differentiators of the disclosed architecture.

### Operational Participation Density Foundation

Operational Participation Density corresponds to survivability-oriented runtime participation pressure associated with time-space-relation participation conditions.

Operational Participation Density may include one or more of temporal participation pressure, spatial participation pressure, relational participation pressure, continuity participation pressure, distributed runtime participation pressure, environmental participation pressure, resource participation pressure, runtime instability pressure, replay participation pressure, synchronization participation pressure, or combinations thereof.

A non-limiting OPD relationship may correspond to:

$$OPD = α {T}_{p} + β {S}_{p} + γ {R}_{p} + δ {C}_{p} + η {D}_{p} + ζ {E}_{p} + λ {P}_{p}$$

where:
Tₚ=temporal runtime participation pressure;
Sₚ=spatial runtime participation pressure;
Rₚ=relational runtime participation pressure;
Cₚ=continuity runtime participation pressure;
Dₚ=distributed runtime participation pressure;
Eₚ=environmental runtime participation pressure;
Pₚ=participation survivability pressure.

The foregoing weighting coefficients may vary according to runtime deployment conditions, distributed runtime conditions, resource conditions, communication conditions, latency conditions, replay conditions, synchronization conditions, environmental conditions, survivability conditions, or combinations thereof.

### Participation Contraction Foundation

Participation contraction corresponds to contraction of active runtime participation toward bounded survivability-useful Runtime Memory Participation subsets.

A non-limiting participation contraction relationship may correspond to:

$$RPC ∝ OPD \cdot {C}_{surv}$$

where:
RPC=Runtime Participation Contraction;
OPD=Operational Participation Density;
Cₛᵤᵣᵥ=participation survivability cost.

Participation contraction may include active runtime participation reduction, runtime replay suppression, runtime synchronization suppression, runtime communication suppression, runtime expansion suppression, runtime participation bounding, runtime participation attenuation, runtime participation dormancy, or combinations thereof.

Participation contraction may dynamically vary according to survivability-oriented runtime participation conditions.

Participation contraction does not require complete runtime participation elimination.

Instead, participation contraction selectively preserves survivability-useful Runtime Memory Participation structures associated with runtime survivability stabilization.

### Bounded Participation Foundation

The disclosed architecture preserves runtime survivability through bounded runtime participation.

A non-limiting bounded participation relation may correspond to:

$${M}_{active} \leq {M}_{max}$$

where:
M_{active}=active runtime participation;
Mₘₐₓ=survivability-stabilized active runtime participation boundary.

Mₘₐₓ may vary according to resource conditions, runtime survivability conditions, Operational Participation Density conditions, participation survivability cost conditions, distributed runtime conditions, communication conditions, latency conditions, governance stabilization conditions, or combinations thereof.

Thus, active runtime participation remains bounded under increasing runtime participation pressure conditions.

Bounded runtime participation may preserve survivability-oriented runtime continuity despite suppression of survivability-noncritical runtime participation structures.

### Runtime Participation Ecology Foundation

Runtime participation structures may transition among multiple participation states.

The disclosed runtime participation ecology may include active runtime participation states, reduced runtime participation states, dormant runtime participation states, attenuated runtime participation states, reconstructable runtime participation states, excluded runtime participation states, or combinations thereof.

Participation state transitions may dynamically occur according to Operational Participation Density conditions, participation survivability cost conditions, runtime continuity conditions, resource conditions, behavioral-relational continuity conditions, distributed runtime conditions, runtime survivability conditions, governance stabilization conditions, or combinations thereof.

Runtime participation ecology stabilization may suppress unrestricted persistent runtime participation activation.

Runtime participation ecology does not require centralized orchestration scheduling architectures.

### Memory Explosion Prevention Foundation

Conventional runtime memory systems may permit unrestricted active runtime participation growth according to historical runtime accumulation.

For N runtime sensors:

$${M}_{raw} = N \cdot {f}_{s} \cdot d \cdot t$$

Pairwise runtime relations may correspond to:

$${R}_{raw} = \frac{N ( N - 1 )}{2} \cdot {f}_{r} \cdot t$$

Accordingly, unrestricted active runtime participation may increase combinatorially.

The foregoing relations are non-limiting engineering illustrations associated with runtime participation growth behavior.

The disclosed architecture suppresses unrestricted active runtime participation expansion through Operational Participation Density-guided participation contraction, bounded survivability-useful Runtime Memory Participation subsets, selective Runtime Memory Participation, runtime participation ecology transitions, reduced runtime participation states, dormant runtime participation states, reconstructable runtime participation states, governance stabilization conditions, or combinations thereof.

Thus:
active runtime participation/unrestricted historical accumulation.

Instead:
active runtime participation=bounded survivability-useful Runtime Memory Participation subsets associated with runtime survivability stabilization.

### Runtime Survivability Foundation

Runtime survivability may correspond to survivability stabilization capability represented by:

$$RS = K \cdot \frac{M \cdot RC \cdot {A}_{c}}{OPD \cdot {C}_{surv} + ε}$$

where:
RS=runtime survivability stabilization capability;
K=normalization coefficient;
M=Runtime Memory Participation capability;
RC=reconstructable continuity capability;
A_{c}=admissible runtime participation continuity capability;
OPD=Operational Participation Density;
Cₛᵤᵣᵥ=participation survivability cost;
ε=bounded stabilization coefficient.

Increasing Runtime Memory Participation capability, reconstructable continuity capability, admissible runtime participation continuity capability, and lineage continuity capability may increase runtime survivability stabilization capability.

Increasing Operational Participation Density conditions and participation survivability cost conditions may increase participation contraction conditions associated with survivability stabilization.

### Runtime Memory Participation Foundation

Runtime Memory Participation differs fundamentally from conventional storage architectures.

Conventional storage architectures generally preserve raw data, historical data, replay data, synchronization data, state snapshots, database records, logging structures, cache structures, or combinations thereof.

The disclosed Runtime Memory Participation architecture instead preserves survivability-preserving admissible runtime participation capability associated with behavioral continuity, relational continuity, participation continuity, reconstructable continuity, runtime survivability continuity, distributed runtime continuity, autonomous runtime continuity, runtime stabilization continuity, governance continuity, lineage continuity, or combinations thereof.

Thus, Runtime Memory Participation structures are not merely historical records.

Runtime Memory Participation structures correspond to runtime participation capability associated with survivability-preserving runtime participation behavior.

Runtime Memory Participation structures may preserve behavioral-relational continuity stabilization associated with survivability-oriented runtime participation conditions.

### Behavioral-Relational Memory Participation

Behavioral-relational Runtime Memory Participation structures may preserve behavioral participation patterns, behavioral continuity structures, behavioral stabilization structures, runtime interaction patterns, relational continuity structures, coordination participation structures, runtime survivability participation structures, distributed participation relationships, runtime stabilization relationships, runtime dependency relationships, runtime admissibility structures, governance stabilization relationships, AI fusion stabilization participation relationships, lineage continuity relationships, or combinations thereof.

AI fusion participation structures correspond to survivability-oriented bounded participation continuity relationships rather than unrestricted cognition generation architectures.

Accordingly, Runtime Memory Participation may preserve how runtime structures participated and survived rather than merely preserving raw data values.

### Selective Memory Participation Relationship

Selective Runtime Memory Participation may correspond to:

$${M}_{s} = \{ {m}_{i} \vert {U}_{i} {RC}_{i} {A}_{i} {P}_{i} \geq {θ}_{m} \}$$

where:
Mₛ=survivability-useful Runtime Memory Participation subset;
mᵢ=candidate Runtime Memory Participation structure;
Uᵢ=survivability usefulness;
RCᵢ=reconstructable continuity capability;
Aᵢ=admissibility capability;
Pᵢ=participation stabilization value;
θₘ=Runtime Memory Participation threshold.

The foregoing relationship suppresses unrestricted Runtime Memory Participation expansion.

### Intrinsic Runtime Memory Participation Foundation

Intrinsic Runtime Memory Participation corresponds to Runtime Memory Participation activation under survivability-critical runtime participation conditions without exhaustive runtime recomputation.

Conventional runtime architectures often require runtime recomputation, distributed synchronization, runtime replay reconstruction, runtime negotiation, runtime coordination, runtime recalculation, distributed AI inference recomputation, or combinations thereof before runtime participation activation.

The disclosed architecture instead permits survivability-preserving Runtime Memory Participation activation without exhaustive runtime recomputation under survivability-critical runtime participation conditions.

A non-limiting intrinsic participation activation relationship may correspond to:

$$IPA \to 1 as OPD ⩾ θ$$

In non-limiting implementations:

$$0.9 ⩽ {θ}_{s} ⩽ 1.$$

The foregoing relationship is a non-limiting survivability-oriented admissibility example and does not require deterministic activation behavior.

### Behavioral-Relational Reconstructable Continuity

Behavioral-relational reconstructable continuity may preserve runtime survivability continuity associated with Runtime Memory Participation structures.

Reconstructable continuity may include behavioral continuity, relational continuity, participation continuity, distributed runtime continuity, runtime survivability continuity, runtime stabilization continuity, autonomous runtime continuity, AI fusion continuity, multi-modal continuity, governance continuity, lineage continuity, or combinations thereof.

A reconstructable continuity relationship may correspond to:

$$RC = {\sum }_{i = 1}^{n} {w}_{i} {C}_{i}$$

where:
RC=reconstructable continuity capability;
Cᵢ=continuity contribution component;
wᵢ=continuity weighting coefficient.

### Distributed Runtime Survivability Foundation

The disclosed architecture may operate across distributed runtime participation domains including distributed runtime nodes, edge runtime systems, cloud runtime systems, autonomous runtime systems, distributed sensor systems, distributed coordination systems, distributed synchronization systems, distributed replay systems, resource-constrained runtime systems, degraded runtime systems, mobile runtime systems, wireless runtime systems, MANET runtime systems, or combinations thereof.

Distributed runtime survivability differs fundamentally from centralized runtime survivability.

The disclosed architecture preserves distributed runtime survivability through bounded synchronization participation, bounded replay participation, distributed reconstructable continuity, Runtime Memory Participation stabilization, participation contraction, and governance stabilization rather than unrestricted distributed runtime computational expansion.

### Autonomous Runtime Survivability Foundation

Autonomous runtime systems may include autonomous drones, autonomous robotics systems, autonomous navigation systems, distributed autonomous runtime systems, autonomous edge runtime systems, autonomous industrial runtime systems, autonomous transportation systems, distributed autonomous sensing systems, or combinations thereof.

The disclosed architecture preserves autonomous runtime survivability through intrinsic Runtime Memory Participation, bounded survivability-useful runtime participation subsets, autonomous participation contraction, behavioral-relational reconstructable continuity, lineage continuity, and Operational Participation Density-guided runtime participation stabilization.

The disclosed architecture does not require unrestricted autonomous reasoning, unrestricted cognition simulation, or unrestricted autonomous computational expansion.

### Governance Stabilization Foundation

The disclosed architecture preserves runtime survivability through governance-guided runtime participation stabilization.

Operational Participation Density governance may govern runtime participation activation, runtime participation contraction, runtime participation suppression, runtime participation attenuation, runtime participation dormancy, runtime participation reconstruction, runtime synchronization participation, runtime replay participation, runtime communication participation, or combinations thereof.

A non-limiting governance stabilization relation may correspond to:

$$GS ∝ \frac{M \cdot RC \cdot U}{OPD \cdot RC + ε}$$

where:
GS=governance stabilization capability.

### Foundation Summary

The disclosed Runtime Memory Participation structures, participation contraction structures, bounded participation structures, reconstructable continuity structures, governance stabilization structures, runtime participation ecology structures, and lineage continuity structures may operate within one or more constitutional runtime participation domains associated with survivability-preserving admissible runtime participation boundaries.

The disclosed architecture therefore establishes an intelligent survivability-oriented runtime participation framework in which:
Operational Participation Density governs runtime participation pressure;
Runtime Memory Participation preserves survivability-preserving admissible participation capability;
participation contraction suppresses unrestricted runtime participation expansion;
bounded survivability-useful Runtime Memory Participation subsets preserve runtime survivability stabilization;
runtime participation ecology structures dynamically transition according to survivability conditions;
distributed reconstructable continuity preserves distributed runtime survivability continuity;
governance stabilization preserves survivability-oriented runtime participation continuity;
AI fusion stabilization preserves bounded survivability-oriented inference continuity;
lineage continuity preserves survivability-oriented runtime participation continuity reconstruction;
and runtime survivability is preserved through selective Runtime Memory Participation rather than unrestricted runtime computational expansion.

### Representative Constitutional Engineering Implementation Cases

### Autonomous Drone Collision Implementation Case

An autonomous drone runtime participation environment may include navigation participation structures, sensor fusion participation structures, terrain analysis participation structures, runtime stabilization participation structures, distributed communication participation structures, or combinations thereof.

Assume:
the autonomous drone operates within mountainous terrain;
GPS participation becomes unstable;
distributed communication becomes intermittent;
sensor participation becomes partially conflicting;
environmental instability increases;
terrain proximity decreases;
or combinations thereof.

Operational Participation Density conditions may therefore increase according to navigation instability, sensor conflict, environmental uncertainty, runtime fragmentation, communication degradation, latency instability, or combinations thereof.

A conventional runtime architecture may attempt full terrain recomputation, full sensor replay reconstruction, full synchronization participation, full distributed coordination participation, full path replanning participation, or combinations thereof.

Under survivability-critical runtime participation conditions, unrestricted runtime computational expansion may increase latency participation cost, runtime instability, collision probability, resource instability, or combinations thereof.

The disclosed architecture instead evaluates survivability-oriented Runtime Memory Participation structures associated with previous survivability-preserving obstacle-avoidance participation, behavioral-relational terrain avoidance continuity, runtime stabilization participation, collision-avoidance participation continuity, or combinations thereof.

A non-limiting intrinsic participation relation may correspond to:

$${IPA}_{a} →︀ 1 as {OPD}_{a} \geq 0.95$$

Assume:

$${OPD}_{a} = 0.97$$

Under survivability-critical runtime participation conditions:
intrinsic Runtime Memory Participation activates;
non-critical replay participation becomes attenuated;
distributed synchronization participation becomes bounded;
runtime communication participation becomes delayed;
runtime participation contraction occurs;
collision-avoidance Runtime Memory Participation structures activate;
or combinations thereof.

Accordingly, runtime survivability stabilization occurs without exhaustive runtime recomputation expansion.

### Distributed Swarm Fragmentation Implementation Case

A distributed autonomous swarm runtime participation environment may include distributed drones, distributed robotics systems, distributed sensor systems, distributed coordination systems, distributed replay systems, or combinations thereof.

Assume:
runtime topology becomes fragmented;
wireless runtime participation becomes unstable;
distributed replay divergence increases;
distributed synchronization instability increases;
runtime coordination instability increases;
or combinations thereof.

Operational Participation Density conditions may therefore increase across distributed runtime participation domains.

A non-limiting distributed Operational Participation Density relation may correspond to:

$${OPD}_{d} = {OPD}_{s} + {OPD}_{r} + {OPD}_{f} + {OPD}_{c}$$

where:
OPDₛ=synchronization instability participation pressure;
OPDᵣ=replay instability participation pressure;
OPD_{f}=fragmentation participation pressure;
OPD_{c}=coordination instability participation pressure.

### Assume:

$${OPD}_{d} = 0.88$$

Under increasing distributed runtime participation pressure conditions:
participation contraction occurs;
distributed replay participation becomes bounded;
distributed synchronization participation becomes bounded;
distributed Runtime Memory Participation stabilizes;
runtime participation ecology transitions occur;
or combinations thereof.

Distributed Runtime Memory Participation structures associated with survivability-preserving runtime coordination continuity may remain active while non-essential runtime participation structures transition into attenuated participation states, dormant participation states, reconstructable participation states, or combinations thereof.

Thus, distributed runtime survivability stabilization remains preserved across fragmented runtime participation domains.

### Edge Memory Saturation Implementation Case

An edge runtime participation environment may include resource-constrained runtime systems, distributed sensing systems, distributed replay systems, runtime coordination systems, or combinations thereof.

Assume:
runtime memory accumulation continuously increases;
replay participation continuously increases;
distributed synchronization participation continuously increases;
runtime resource participation decreases;
or combinations thereof.

Conventional runtime architectures may permit unrestricted runtime accumulation until runtime destabilization occurs.

The disclosed architecture instead evaluates Runtime Memory Participation according to survivability usefulness conditions.

A non-limiting Runtime Memory Participation selection relation may correspond to:

$${M}_{active} = \{ {m}_{i} \vert {U}_{i} {RC}_{i} {A}_{i} {P}_{i} \geq {θ}_{m} \}$$

Assume:
M_{raw}(t)=10\hat{ }8 runtime participation structures;
R_{raw}(t)=10\hat{ }10 runtime replay relationships;
but
M_{active}(t)=10\hat{ }4 survivability-useful Runtime Memory Participation structures.

Thus:

$${M}_{active} ( t ) \backslash II {M}_{raw} ( t ) + {R}_{raw} ( t )$$

Under increasing Operational Participation Density conditions:
runtime participation contraction increases;
runtime participation attenuation increases;
runtime participation dormancy increases;
bounded Runtime Memory Participation stabilizes;
or combinations thereof.

Accordingly, runtime survivability stabilization occurs without unrestricted memory accumulation explosion.

### AI Fusion Instability Implementation Case

An AI fusion runtime participation environment may include multi-modal sensing participation structures, distributed inference participation structures, sensor fusion participation structures, runtime coordination participation structures, behavioral-relational Runtime Memory Participation structures, or combinations thereof.

Assume:
distributed sensor disagreement increases;
environmental instability increases;
distributed inference instability increases;
runtime synchronization instability increases;
communication degradation increases;
or combinations thereof.

Operational Participation Density conditions may therefore increase according to survivability-oriented runtime participation pressure conditions associated with distributed inference instability.

A conventional runtime architecture may attempt unrestricted inference recomputation, unrestricted synchronization participation, unrestricted replay participation, unrestricted distributed coordination participation, unrestricted multi-modal inference propagation participation, or combinations thereof.

Under survivability-critical runtime participation conditions, unrestricted runtime computational expansion may increase latency instability, distributed inference instability, runtime survivability cost, synchronization instability, replay instability, or combinations thereof.

The disclosed architecture instead selectively activates Runtime Memory Participation structures associated with survivability-preserving bounded inference continuity, behavioral-relational reconstructable continuity, bounded synchronization participation, bounded replay participation, participation contraction, governance stabilization, AI fusion continuity stabilization, or combinations thereof.

A non-limiting bounded AI fusion stabilization relation may correspond to:

$${AIF}_{s} ∝ \frac{RC \cdot M}{OPD \cdot {C}_{surv} + ε}$$

where:
AIFₛ=AI fusion survivability stabilization capability;
RC=reconstructable continuity capability;
M=Runtime Memory Participation capability;
OPD=Operational Participation Density;
Cₛᵤᵣᵥ=participation survivability cost.

Accordingly, survivability-oriented AI fusion continuity may remain stabilized without unrestricted inference recomputation expansion, unrestricted distributed synchronization expansion, or unrestricted runtime participation accumulation.

### Manet Communication Degradation Implementation Case

A distributed MANET runtime participation environment may include mobile runtime nodes, distributed wireless participation structures, dynamic routing participation structures, distributed synchronization participation structures, replay participation structures, edge runtime participation structures, or combinations thereof.

Assume:
wireless runtime participation becomes intermittent;
distributed runtime topology continuously changes;
runtime communication latency increases;
packet participation instability increases;
distributed synchronization participation becomes fragmented;
runtime coordination participation becomes partially unavailable;
or combinations thereof.

Operational Participation Density conditions may therefore increase according to distributed communication instability, runtime topology fragmentation, synchronization instability, replay instability, latency instability, runtime coordination instability, or combinations thereof.

A conventional runtime architecture may attempt unrestricted distributed synchronization participation, unrestricted runtime replay participation, unrestricted routing recomputation participation, unrestricted distributed coordination participation, unrestricted communication recovery participation, or combinations thereof.

Under survivability-critical runtime participation conditions, unrestricted distributed runtime computational expansion may increase communication instability, runtime congestion participation, synchronization instability, replay divergence instability, latency instability, resource instability, or combinations thereof.

The disclosed architecture instead selectively preserves survivability-useful Runtime Memory Participation structures associated with bounded communication continuity, bounded synchronization participation, reconstructable runtime continuity, distributed participation stabilization, runtime participation contraction, runtime participation dormancy, governance stabilization, or combinations thereof.

A non-limiting distributed survivability relation may correspond to:

$${MS}_{c} ∝ \frac{RC \cdot M}{{OPD}_{c} \cdot {C}_{surv} + ε}$$

where:
MS_{c}=MANET survivability stabilization capability;
RC=reconstructable continuity capability;
M=Runtime Memory Participation capability;
OPD_{c}=communication participation pressure;
Cₛᵤᵣᵥ=participation survivability cost.

Under increasing communication participation pressure conditions:
distributed synchronization participation becomes bounded;
runtime replay participation becomes bounded;
non-essential communication participation structures become attenuated;
Runtime Memory Participation continuity becomes stabilized;
distributed runtime participation contraction occurs;
or combinations thereof.

Accordingly, distributed runtime survivability continuity may remain preserved despite degraded MANET runtime participation conditions.

### Runtime Reconstruction Implementation Case

A survivability-oriented runtime reconstruction environment may include distributed runtime participation structures, Runtime Memory Participation structures, replay participation structures, synchronization participation structures, autonomous runtime participation structures, distributed AI participation structures, or combinations thereof.

Assume:
runtime interruption occurs;
distributed runtime participation becomes partially unavailable;
runtime participation fragmentation occurs;
synchronization participation becomes incomplete;
replay participation becomes partially inconsistent;
runtime continuity instability increases;
or combinations thereof.

A conventional runtime architecture may attempt exhaustive runtime replay reconstruction, unrestricted distributed synchronization participation, unrestricted historical runtime restoration participation, unrestricted distributed recomputation participation, unrestricted runtime regeneration participation, or combinations thereof.

Under survivability-critical runtime participation conditions, unrestricted runtime reconstruction expansion may increase replay instability, synchronization instability, latency instability, distributed runtime instability, resource instability, or combinations thereof.

The disclosed architecture instead selectively reconstructs survivability-useful Runtime Memory Participation structures associated with behavioral-relational reconstructable continuity, bounded replay participation, bounded synchronization participation, runtime participation stabilization, governance stabilization, distributed reconstructable continuity, lineage continuity stabilization, or combinations thereof.

A non-limiting runtime reconstruction relation may correspond to:

$${RR}_{s} ∝ \frac{M \cdot RC \cdot {A}_{c}}{{R}_{p} \cdot {C}_{surv} + ε}$$

where:
RRₛ=runtime reconstruction survivability capability;
M=Runtime Memory Participation capability;
RC=reconstructable continuity capability;
A_{c}=admissible runtime participation continuity capability;
Rₚ=replay participation pressure;
Cₛᵤᵣᵥ=participation survivability cost.

Under survivability-critical runtime participation conditions:
Runtime Memory Participation reconstruction activates;
bounded replay participation occurs;
distributed synchronization participation becomes selective;
non-essential runtime participation structures remain dormant;
runtime participation contraction occurs;
behavioral-relational continuity becomes reconstructable;
lineage continuity becomes reconstructable;
or combinations thereof.

Accordingly, runtime survivability continuity may remain reconstructable without unrestricted historical runtime restoration expansion or unrestricted distributed recomputation expansion.

1. An intelligent survivability-oriented runtime participation platform comprising:
a Runtime Memory Participation architecture configured to maintain Runtime Memory Participation structures associated with survivability-preserving admissible runtime participation;
an Operational Participation Density governance architecture configured to determine Operational Participation Density associated with survivability-oriented runtime participation pressure conditions including temporal participation conditions, spatial participation conditions, relational participation conditions, continuity conditions, or combinations thereof;
a selective runtime participation steering architecture configured to selectively activate, contract, bound, reconstruct, or prevent runtime participation according to Operational Participation Density conditions;
a behavioral-relational continuity preservation architecture configured to preserve behavioral-relational participation continuity associated with admissible runtime participation;
a reconstructable continuity participation architecture configured to preserve reconstructable continuity associated with Runtime Memory Participation structures; and
a survivability participation stabilization architecture configured to preserve runtime survivability through Operational Participation Density-guided selective Runtime Memory Participation under time-space-relation participation pressure conditions;
wherein increasing runtime participation pressure contracts active runtime participation toward bounded survivability-useful Runtime Memory Participation subsets under increasing Operational Participation Density conditions;
wherein unrestricted runtime participation expansion is suppressed under increasing Operational Participation Density conditions through selective Runtime Memory Participation contraction; and
wherein survivability-expensive runtime participation is selectively contracted, bounded, recomposed, intrinsically activated through selective Runtime Memory Participation, or prevented from unrestricted participation according to Operational Participation Density conditions.

2. The platform of claim 1, wherein Runtime Memory Participation corresponds to survivability-preserving admissible participation capability associated with behavioral continuity, relational continuity, participation continuity, reconstructable continuity, survivability continuity, or combinations thereof.

3. The platform of claim 1, wherein Operational Participation Density corresponds to survivability-oriented runtime participation pressure associated with temporal participation conditions, spatial participation conditions, relational participation conditions, continuity conditions, or combinations thereof.

4. The platform of claim 1, wherein runtime participation is selectively activated according to survivability usefulness associated with admissible runtime participation.

5. The platform of claim 1, wherein runtime participation structures transition among active participation states, reduced participation states, dormant participation states, attenuated participation states, reconstructable participation states, or combinations thereof according to Operational Participation Density conditions.

6. The platform of claim 1, wherein runtime participation operates through layered and temporally distributed participation activation associated with participation survivability cost and participation priority.

7. The platform of claim 1, wherein Runtime Memory Participation selectively recomposes behavioral memory structures, relational memory structures, participation memory structures, survivability memory structures, or combinations thereof to form new admissible runtime participation structures.

8. The platform of claim 1, wherein reconstructable continuity corresponds to behavioral-relational reconstructable continuity associated with Runtime Memory Participation structures.

9. An intelligent survivability-oriented runtime participation platform comprising:
an Operational Participation Density governance architecture configured to determine survivability-oriented runtime participation pressure conditions;
a bounded runtime participation architecture configured to maintain active runtime participation according to survivability usefulness conditions and Operational Participation Density conditions rather than unrestricted historical accumulation;
a participation contraction architecture configured to contract runtime participation according to increasing Operational Participation Density conditions and participation survivability cost conditions; and
a survivability stabilization architecture configured to preserve runtime survivability through bounded survivability-useful runtime participation subsets without unrestricted active runtime participation expansion.

10. The platform of claim 9, wherein active runtime participation remains bounded according to Operational Participation Density conditions.

11. The platform of claim 9, wherein selective Runtime Memory Participation reduces survivability-expensive runtime computational participation under Operational Participation Density conditions.

12. The platform of claim 9, wherein survivability-preserving runtime participation continuity is maintained through Runtime Memory Participation without unrestricted replay participation.

13. The platform of claim 9, wherein survivability-preserving runtime participation continuity is maintained through Runtime Memory Participation without unrestricted synchronization participation.

14. The platform of claim 9, wherein runtime participation steering preserves runtime survivability through bounded survivability-useful participation subsets.

15. An intelligent survivability-oriented runtime participation platform comprising:
an intrinsic Runtime Memory Participation architecture configured to activate Runtime Memory Participation under survivability-critical runtime participation conditions without exhaustive runtime recomputation and without unrestricted computational participation expansion under survivability-critical runtime participation conditions;
a behavioral-relational continuity preservation architecture configured to preserve behavioral-relational participation continuity associated with Runtime Memory Participation;
a reconstructable continuity participation architecture configured to preserve reconstructable continuity associated with Runtime Memory Participation structures; and
a survivability stabilization architecture configured to preserve runtime survivability through intrinsic Runtime Memory Participation reducing survivability-expensive runtime recomputation under survivability-critical runtime participation conditions.

16. The platform of claim 15, wherein intrinsic Runtime Memory Participation preserves runtime survivability under survivability-critical runtime conditions.

17. The platform of claim 15, wherein the runtime participation platform operates within distributed runtime participation environments.

18. The platform of claim 15, wherein Operational Participation Density conditions are associated with degraded runtime communication conditions.

19. The platform of claim 15, wherein runtime participation structures are selectively activated according to bounded runtime resource conditions.

20. The platform of claim 15, wherein reconstructable behavioral-relational participation continuity is preserved across distributed runtime participation domains.
